(19) United States
(12) Patent Application Publication
(10) Pub. No.: US 2016/0042575 A1
(43) Pub. Date: Feb. 11, 2016

(54) AUTOMATED FACILITY ACCESS AND PAYMENT PROCESSING SYSTEMS AND METHODS

(71) Applicant: LOCOMOBI, INC., Toronto (CA)

(72) Inventors: Sukanta Ganguly, San Jose, CA (US); Barney Pell, San Francisco, CA (US); Grant Furlane, Oakville (CA)

(21) Appl. No.: 14/823,811

(22) Filed: Aug. 11, 2015

Related U.S. Application Data
(60) Provisional application No. 62/036,086, filed on Aug. 11, 2014.

(51) Int. Cl. G07B 15/02

(52) U.S. Cl. CPC G07B 15/02

(57) ABSTRACT

An automated parking facility access and payment processing system is provided. The system includes a parking facility server located proximate to a parking facility, a central authentication and payment processing server for authenticating and processing payment for a user of parking facilities, a gate controller positioned proximate to a barrier gate at the parking facility, and at least one of an identification module connected to a vehicle, and a user computer device including or accessing an automated parking and payment processing application. The gate controller is configured to receive, via Bluetooth communication with the at least one of an identification module and a user computer device, identification information about a user seeking entry into the parking facility, and to relay the identification information to the parking facility server. The central authentication and payment processing server is configured to receive the identification information from the parking facility server and verify that the user is a valid account holder within the system. The parking facility server is configured to receive verification from the central authentication and payment processing server and to signal the gate controller to open the barrier gate and allow the user's vehicle to enter the parking facility. The gate controller is further configured to detect entry of the vehicle into the parking facility and to provide notification to the central authentication and payment processing server, via the parking facility server, for payment processing.

### CROSS REFERENCE TO RELATED APPLICATION

This application claims priority from U.S. Provisional Application Ser. No. 62/036,086, filed Aug. 11, 2014, the contents of which are incorporated herein by reference.

### FIELD OF THE INVENTION

The present disclosure is generally related to communication between a mobile device and a gateway device having Internet connectivity. More particularly, the disclosure is related to systems and methods for automated facility access and payment processing. Most particularly, the facility may be a parking facility.

### BACKGROUND OF THE INVENTION

There is an increasing demand by users for convenient systems based on Internet-connected devices, including mobile telephones, hand-held devices, car-phones, laptop computers, or other electronic devices to obtain and pay for goods or services. Often, these devices use software commonly known as an application, or “app”; a piece of software that can run on the Internet, on a computer, on a mobile phone or other electronic device.

Entry systems use a variety of ways to record when a person or vehicle enters and exits a facility or space. Some entry systems may charge an entrance fee, either flat or incremental. When charging an increment fee, many existing systems time-stamp entry and exit to determine elapsed time and calculate the proper incremental rate.

As a non-limiting description of related art, some entry and exit transactions occur at parking facilities. Attended parking facilities may have a worker on site to record vehicle arrival and accept payment upon the vehicle leaving. These attended parking facilities may charge a variable fee based on the length of time that a vehicle is parked in the lot, garage or other parking facility.

Unattended parking facilities may not have an attendant on site throughout the entire day, so the attendant is not there to record when vehicles arrive or leave. Therefore these parking facilities typically charge a flat fee. Other unattended facilities do not have a gate or full-time attendant, and a worker goes to the facility at various times during the day to determine if all parked vehicles have paid the entrance fee. Alternatively, some unattended parking facilities charge a variable fee based on the length of time parked; however, these facilities make a substantial investment in gates, gate arms or other movable barriers, and terminals to record the time of entrance, exit and determine elapsed time and incremental fee.

Thus, a heretofore unaddressed need exists in the industry to address the aforementioned deficiencies and inadequacies.

### SUMMARY OF THE INVENTION

Embodiments of the present disclosure provide parking facility access and payment processing systems and methods. Briefly described, in architecture, one embodiment of a system, among others, can be implemented as follows. The system includes a parking facility server located proximate to a parking facility, a central authentication and payment processing server for authenticating and processing payment for a user of parking facilities, a gate controller positioned proximate to a barrier gate at the parking facility, and at least one of an identification module connected to a vehicle, and a user computer device including or accessing an automated parking and payment processing application. The gate controller is configured to receive, via Bluetooth communication with the at least one of an identification module and a user computer device, identification information about a user seeking entry into the parking facility, and to relay the identification information to the parking facility server. The central authentication and payment processing server is configured to receive the identification information from the parking facility server and verify that the user is a valid account holder within the system. The parking facility server is configured to receive verification from the central authentication and payment processing server and to signal the gate controller to open the barrier gate and allow the user's vehicle to enter the parking facility. The gate controller is further configured to detect entry of the vehicle into the parking facility and to provide notification to the central authentication and payment processing server, via the parking facility server, for payment processing.

In accordance with one aspect of the present invention, there is disclosed an automated facility access and payment processing system, comprising:

an access control device located at a facility, said access control device being configured to grant or deny a user access to or from said facility;

an access control device controller operatively connected to said access control device and configured to cause said access control device to grant or deny said user access to or from said facility;

at least one of: an identification module connected to a vehicle, and a user computer device, each containing user identification information; and

a two-way communication means between said at least one of said identification module and said user computer device, and said access control device controller to allow said at least one of said identification module and said user computer device to transmit said user identification information to said access control device controller in response to receiving a request for said user identification information from said access control device controller;

at least one server operatively connected to said access control device controller, said at least one server being configured to:
a. receive said user identification information from said access control device controller;
b. use said received user identification information to authenticate and process payment for said user; and
c. signal said access control device controller to cause said access control device to grant said user access to or from said facility.

In accordance with another aspect of the present invention, there is disclosed an automated parking facility access and payment processing system, comprising:

a parking facility server located proximate to a parking facility;

a central authentication and payment processing server for authenticating and processing payment for a user of parking facilities;

a gate controller positioned proximate to a barrier gate at the parking facility; and

at least one of: an identification module connected to a vehicle, and a user computer device including or accessing an automated parking and payment processing application;

wherein the gate controller is configured to receive, via Bluetooth communication with the at least one of an identification module and a user computer device, identification information about a user seeking entry into the parking facility, and to relay the identification information to the parking facility server;

wherein the central authentication and payment processing server is configured to receive the identification information from the parking facility server and verify that the user is a valid account holder within the system;

wherein the parking facility server is configured to receive verification from the central authentication and payment processing server and to signal the gate controller to open the barrier gate and allow the user's vehicle to enter the parking facility; and

wherein the gate controller is further configured to detect entry of the vehicle into the parking facility and to provide notification to the central authentication and payment processing server, via the parking facility server, for payment processing.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic illustration of an automated parking facility access and payment processing system, in accordance with a first exemplary embodiment of the present disclosure.

FIG. 2 is a flow chart which schematically illustrates use of the system of FIG. 1 when a user seeks entry to a parking facility, in accordance with embodiments of the present disclosure.

FIG. 3 is a flowchart which schematically illustrates use of the system of FIG. 1 when a user seeks to exit the parking facility, in accordance with embodiments of the present disclosure.

### DETAILED DESCRIPTION OF THE PREFERRED EMBODIMENTS

Many embodiments of the disclosure may take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured or constructed to perform one or more of the computer-executable algorithms described below. Accordingly, the term “computer” as generally used herein refers to any data processor and includes Internet appliances, hand-held devices (including palm-top computers, wearable computers, cellular or mobile phones, multi-processor systems, processor-based or programmable consumer electronics, network computers, minicomputers) and the like.

The disclosure also can be practiced in distributed computing environments, where tasks or modules are performed by remote processing devices that are linked through a communications network. Moreover, the disclosure can be practiced in Internet-based or cloud computing environments, where shared resources, software and information may be provided to computers and other devices on demand. In a distributed computing environment, program modules or subroutines may be located in both local and remote memory storage devices. Aspects of the disclosure described below may be stored or distributed on computer-readable media, including magnetic and optically readable and removable computer disks, fixed magnetic disks, floppy disk drive, optical disk drive, magneto-optical disk drive, magnetic tape, hard-disk drive (HDD), solid state drive (SSD), compact flash or non-volatile memory, as well as distributed electronically over networks including the cloud. Data structures and transmissions of data particular to aspects of the disclosure are also encompassed within the scope of the disclosure.

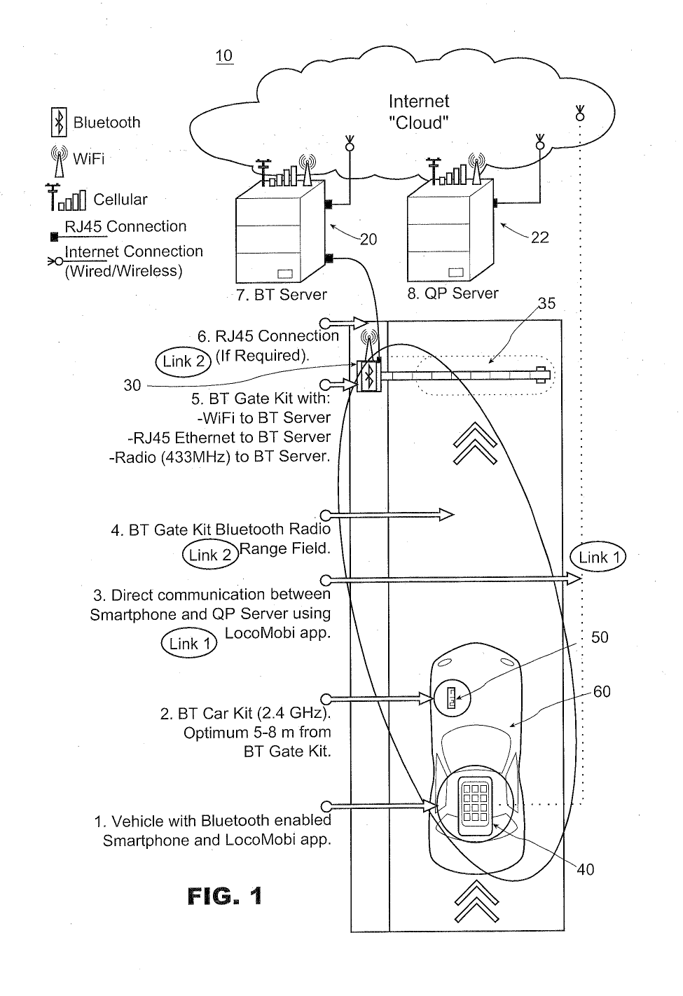

FIG. 1 is a schematic illustration of an automated parking facility access and payment processing system 10, in accordance with a first exemplary embodiment of the present disclosure. The automated parking facility access and payment processing system 10, which may also be referred to as ‘system 10’, includes one or more parking facility servers 20 and a central authentication and payment processing server 22. One or more access control device controllers, or gate controllers 30 are included in the system 10, and are located on or proximate to one or more parking facility gates 35 or other such structures located, for example, at a parking facility entry and/or exit. Most preferably, the gate controllers 30 are operatively connected to gate structures 35 which structures are used for limiting access to the facility. A user computer device (e.g., a smartphone or other mobile computing device) includes or otherwise accesses an automated parking facility access and payment application 40. An identification module 50 may be located onboard a vehicle 60.

The servers 20, 22 may be or include any database capable of storing and/or providing access to information, such as an electronic database, a computer and/or computerized server, database server or generally any network host capable of storing data and connected to any type of data network. Further, the servers 20, 22 may include or be a part of a distributed network or cloud computing environment. Any type of electronic and/or computerized device that is capable of storing information may be included as the servers 20, 22 and is considered within the scope of this disclosure. The servers 20, 22 may include computer-readable storage media, and a processor for processing data and executing algorithms, including any of the processes and algorithms set forth in this disclosure. Furthermore, in other embodiments of the present invention the functionality of the parking facility servers 20 and the central authentication and payment processing server 22 may be combined into a single server, or separated out further to additional servers. Although these other embodiments are comprehended by the present invention, their implementation will be generally understood by those skilled in the art, and so they are not described further herein.

The user computer device may be any device that is capable of communicating with the central authentication and payment processing server 22 via the application 40 (which may be hosted, for example, on the user computer device, the central authentication and payment processing server 22 and/or some combination thereof), and may be operated by any user of the system 10, and particularly those users who use the system 10 to gain access to parking facilities. Any number of user computer devices may use the system 10 at any given time. The user computer device may be any computer, including any personal computer, Internet appliance, hand-held device (including palm-top computers, wearable computers, cellular or mobile phones, multi-processor systems, processor-based or programmable consumer electronics, network computers, minicomputers), onboard vehicle systems, and the like.

The automated parking facility access and payment application 40 may be fully or partially hosted on the central authentication and payment processing server 22 and accessible to a user via a user computer device, through two-way communication through the facility. The application 40 may include any tool, device, system, process or combination thereof, which assists or makes possible providing, for example, automated parking facility access to registered users of the system 10. For example, the application 40 may facilitate the authentication of a registered user through interaction with a parking facility server 20 and/or gate controller 30 at a parking facility which the user is seeking to enter, and may further facilitate automated payment processing for such parking facility access and use. The application 40 may include any computer-readable memory or databases, which may be stored in any computer-readable medium, and may be accessible by a computer processor. The application 40 may further include or access computer program instructions which may cause a processor to perform any algorithms and/or functions which may be described in this disclosure.

The gate controller 30 may, for example, grant access and exit to the parking facility through interaction with the central authentication and payment processing server 22. Communication with the vehicle 60 and/or driver, including credentials and messaging prompts or push notifications issued to the user by the parking facility server 20, and responses issued by the user to the parking facility server 20), is enabled via the application 40, the identification module 50, or a combination thereof, which may be provided by means of local two-way communication between the parking facility server 20 (via the gate controller 30) and the user computer device.

The application 40 may be installed onto each of a plurality of user computer devices (e.g., smartphones) by each end user. The details of each user account can be configured, added and updated either directly from the user's computer device (e.g., by accessing the application 40) or from a dedicated secure website (e.g., which may provide access to the application 40). The user computer device may include Bluetooth communications functionality, which may be required to be turned on in order for the user to seamlessly utilize the automated parking facility access and payment processing system 10.

The automated parking facility access and payment application 40 communicates with:
The gate controller 30 using Bluetooth or Wi-Fi, where identification data is exchanged.
The central authentication and payment processing server 22 via the gate controller 30 (e.g., via communication between the gate controller 30 and the parking facility server 20, and communication between the parking facility server 20 and the central authentication and payment processing server 22) using Bluetooth or Wi-Fi, identifying itself, the account holder and location. (Link 2 in FIG. 1).
The central authentication and payment processing server 22 using a mobile network communication protocol such as GPRS and/or LTE (e.g., when cellular signal is available), identifying itself, the account holder and location. (Link 1 in FIG. 1).

The automated parking facility access and payment application 40 can be used on user computer devices without Bluetooth-functionality (or with Bluetooth disabled) by communicating directly with the central authentication and payment processing server 22 (e.g., via Link 1); however, this has limitations due to the sporadic availability of cellular access in heavily shielded underground parking locations. The use of Bluetooth mode for devices using the application 40 is thus preferred where Wi-Fi or any other two-way communication is not otherwise available.

The onboard identification module 50 may be installed in each vehicle 60 near the front drivers' side headlight assembly, which may ensure close proximity to the gate controller 30 when approaching a gate at a parking facility. Left hand drive vehicles would thus locate the identification module 50 near the front left headlight, while right hand drive vehicles, such as those in the U.K., Singapore and India, would locate the identification module 50 near the right side headlight.

The identification module 50 communicates with:
The application 40, where identification data is exchanged. When the onboard identification module 50 is present, use of the application 40 is optional, as the requisite registered user identification, account information and/or other credentials may be provided from the identification module 50.
The parking facility server 20 via the gate controller 30 (e.g., via communication between the gate controller 30 and the parking facility server 20, and communication between the parking facility server 20 and the central authentication and payment processing server 22) using Bluetooth or Wi-Fi, using a Bluetooth transceiver, identifying itself and the account holder. (Link 2 in FIG. 1).

Because the connection between the onboard identification module 50 and gate controller 30 is made using Bluetooth, the identification module 50 avoids cellular signal limitations which exist in most underground parking facilities. Further, when the identification module 50 is pre-installed in a vehicle 60, access to the system 10 can be made via the credentials or user identification information attached to the vehicle 60 (e.g., via the identification module 50), without need for users to have a mobile phone or other mobile computer device. By way of example, on detecting an approaching vehicle using for example a vehicle detector, mentioned below, the gate controller 30 may initiate a two-way communication with the identification module 50, and request the user identification information (i.e. credentials) attached to the vehicle 60. In response to such a request, the identification module 50 may be configured to transmit the requested user identification information to the gate controller 30, without user input. It is also contemplated that the identification module may be configured to detect the presence of the gate controller 30 and initiate a two-way communication before transmitting the user identification information to the gate controller 30, also without user input. In this sense, the identification module 50 will preferably be a closed system, having the user identification information and certain other preselected user parameters (i.e. permitted parking facilities, permitted parking location(s) within a parking facility, parking fee structure, permitted parking duration, permitted parking times, etc.) stored in a memory of the identification module. By being a closed structure, the user's parking options may be controlled by the fleet operator, who would have access to modify the preselected user parameters (i.e. the preselected parameters may not be modified by the user), or grant such access to others. It is contemplated that such an identification module 50 will be useful for fleet vehicles, so that the users will not need to be distracted from the task of driving by the need to review and select the same user parameters over and over again. However, like the embodiment of the invention utilizing the user computer device, the identification module 50 is adapted to establish two-way communication with the gate controller 30 to send user identification information, and to receive information from the central authentication and payment processing server 22 (i.e. via the gate controller 30 and the parking facility server 20) and store same in a memory for subsequent retrieval by, for example, the same or another gate controller 30, or a separate commercial hub, for billing purposes and/or inventory management. In this way, the system can keep track of, for example, the location of each fleet vehicle, and the location of empty and occupied parking locations.

A fused 5 VDC power supply may be required when connecting the identification module 50 to the vehicle 60. Each identification module 50 contains a unique ID that identifies the vehicle 60 and account holder (or registered user of the system 10) to the central authentication and payment processing server 22.

In a preferred embodiment, the gate controller 30 is operatively connected to one or more barrier gates at a parking facility. In this sense, operatively connected means that the gate controller 30 can communicate with and control the opening and closing of the barrier gates of other facility access control devices. More preferably, the gate controller 30 may be located in close proximity to the one or more barrier gates. The gate controller 30 is the intermediate device that links the onboard identification module 50 to the parking facility server. The gate controller 30 may be required to be located within a certain distance from the parking facility server 20, such as, for example, 1000 m.

The gate controller 30 may house or otherwise include:
A Bluetooth transceiver to communicate with the onboard identification module 50.
A Radio transceiver (e.g., 433 MHz) to communicate with the parking facility server 20.
RJ45 Ethernet port to communicate with the parking facility server 20.

The gate controller 30 also acts as a control board to communicate with the barrier gate 35 (e.g., to control the raising of the gate upon successful authentication). Preferably, the system 10 may include a user detector such as, for example, a radar device, a camera or an induction loop, for detecting entry of a user to, or exit of a user from the facility. Preferably the user detector may be operatively connected to the gate controller 30. For example, in a parking facility where the user will be inside of a vehicle, the user detector may be selected to detect the vehicle (i.e. a vehicle detector), as opposed to the user himself.

The parking facility server 20 is the intermediary interface that functions as the gate keeper, handling transaction queries on behalf of the central authentication and payment processing server 22. The parking facility server 20 may be required to be located within a certain distance from the gate controller 30, such as, for example, 1000 m.

The parking facility server 20 may communicate via:
433 MHz Radio transceiver to communicate with the gate controller 30.
RJ45 Ethernet port to communicate with the gate controller 30.
RJ45 Ethernet port to communicate with the central authentication and payment processing server 22 via the Internet.
Optional Cellular (3G/LTE) connection to the central authentication and payment processing server 22.

The parking facility server 20 relays account queries, recording the ID of each identification module 50, along with the location, allowing vehicular access to the parking facility (e.g., upon successful authentication). The parking facility server 20 also signals the gate controller 30 to open/close the barrier gate 35.

The central authentication and payment processing server 22 performs the transactions for account and client management by communicating with the parking facility server 20.

The central authentication and payment processing server 22 may communicate via:
433 MHz Radio transceiver to communicate with the parking facility server 20 via the Internet.
Optional Cellular (GPRS/LTE) connection to the parking facility server 20.
Optional Cellular (GPRS/LTE) connection with user computer devices including the automated parking facility access and payment application 40.

The central authentication and payment processing server 22 handles all account validation and access/exit requests from the parking facility server 20 and the application 40, and also consolidates transactions and performs billing invoicing.

The system 10 performs its functions in two separate operational sequences: parking facility entrance, and parking facility exit and payment.

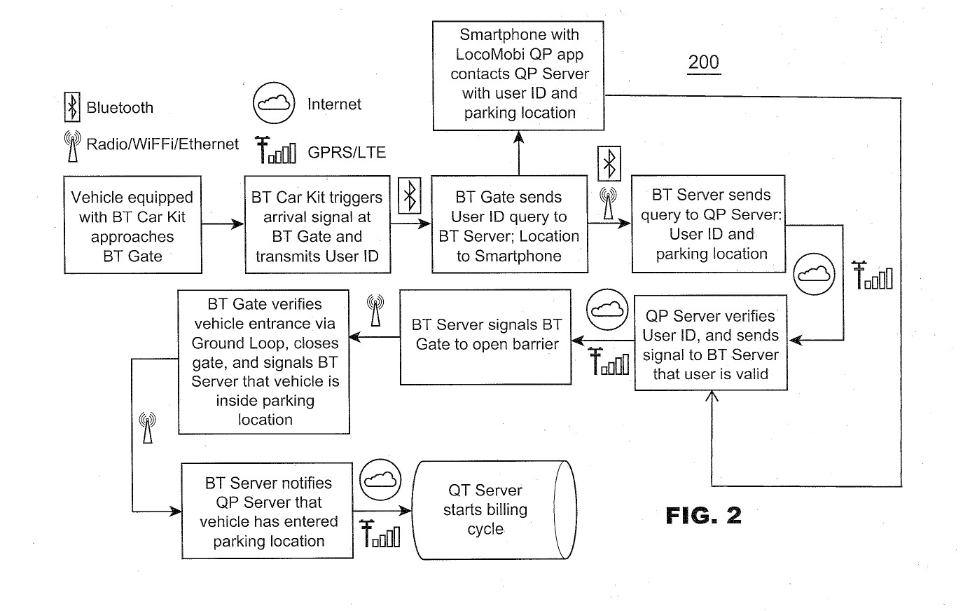

FIG. 2 is a flow chart 200 which schematically illustrates operation of the system 10 during parking facility entrance. It should be noted that any process descriptions or blocks in flow charts should be understood as representing modules, segments, portions of code, or steps that include one or more instructions for implementing specific logical functions in the process, and alternate implementations are included within the scope of the present invention in which functions may be executed out of order from that shown or discussed, including substantially concurrently in reverse order, depending on the functionality involved, as would be understood by those reasonably skilled in the art of the present invention.

As shown in FIG. 2, when the customer is ready to enter the parking facility, the following actions will occur:
1. The parking customer will enter the parking facility with a vehicle 60 containing the onboard identification module 50 and/or a smartphone or other user computer device loaded with the automated parking facility access and payment application 40.
2. Using, for example, Bluetooth, the identification module 50 and/or application 40 communicates with the gate controller 30, identifying the vehicle 60 and the physical location of the parking facility. The application 40 also identifies the user.
3. The gate controller 30 relays vehicle and/or user information from the identification module 50 and/or the application 40 to the parking facility server 20, which will forward information (e.g. location, license plate, user account details, etc.) to the central authentication and payment processing server 22.
4. The central authentication and payment processing server 22 will record this data and confirm the validity of the account.
5. The central authentication and payment processing server 22, after confirming the validity of the account, will communicate this information back to the parking facility server 20 with authorization to open the barrier gate 35.
6. The parking facility server 20 will signal the gate controller 30 to open the barrier gate 35 to allow the vehicle 60 to enter and proceed to park.
7. As the vehicle 60 passes the barrier gate 35 and triggers the detector(s), the gate controller 30 will notify the parking facility server 20 that the vehicle 60 has cleared the entrance and entered the parking facility. The parking facility server 20 will once again notify the central authentication and payment processing server 22, and the billing cycle will commence. Preferably the central authentication and payment processing server 22 will record data such as the entry time and associate it with the other information mentioned above (e.g. location, license plate, user account details, etc.). A notification that the billing cycle has commenced may be transmitted or otherwise accessible to the user (e.g., through email, regular mail, access through the application 40 and so on).

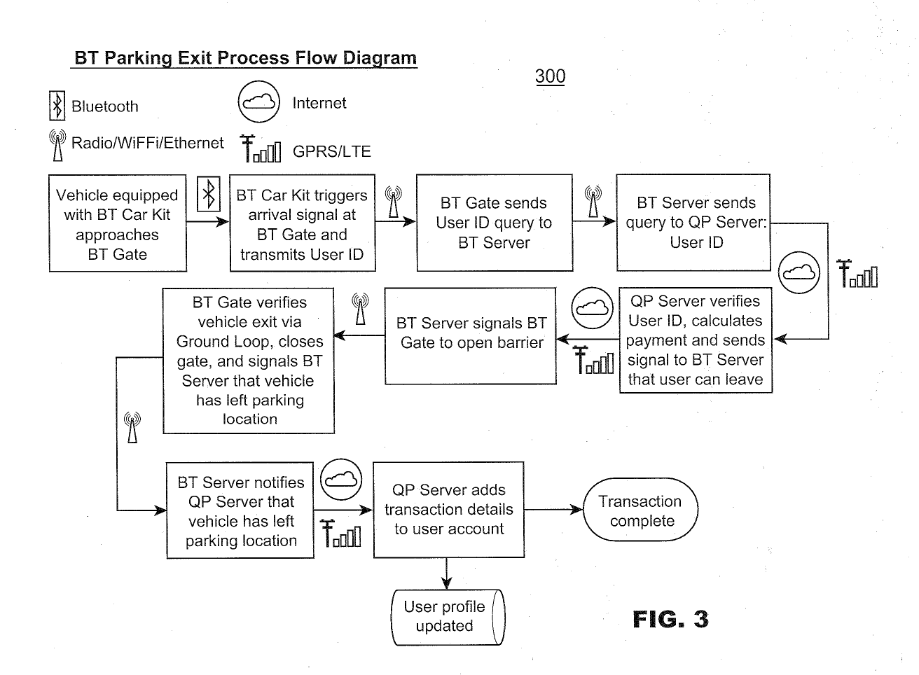

FIG. 3 is a flow chart 300 which schematically illustrates operation of the system 10 during parking facility exit. When the customer is ready to depart the parking facility, the following actions will occur:
1. The parking customer will exit the parking facility with a vehicle 60 containing an onboard identification module 50 and/or a smartphone or other user computer device loaded with the automated parking facility access and payment application 40.
2. Using, for example, Bluetooth, the identification module 50 and/or automated parking facility access and payment application 40 communicates with the gate controller 30, identifying the vehicle and the physical location of the parking facility. The application 40 also identifies the user.
3. The gate controller 30 relays vehicle and/or user information from the identification module 50 and/or the application 40 to the parking facility server 20, which will forward information (e.g., location, license plate, user account details, etc.) to the central authentication and payment processing server 22.
4. The central authentication and payment processing server 22 will record this data and confirm the validity of the account.
5. The central authentication and payment processing server 22, after confirming the validity of the account, will communicate this information back to the parking facility server 20 with authorization to open the barrier gate 35.
6. The parking facility server 20 will signal the gate controller 30 to open the barrier gate 35 to allow the vehicle 60 to exit.
7. As the vehicle 60 passes the barrier gate 35 and triggers the detector(s), the gate controller 30 will notify the parking facility server 20 that the vehicle 60 has cleared the barrier 35 and exited the parking facility. The parking facility server 20 will once again notify the central authentication and payment processing server 22. Preferably the central authentication and payment processing server 22 will record data such as the exit time.
8. The central authentication and payment processing server 22 then calculates the parking costs, adjusts the user's account balance and bills accordingly and creates a record of the completed parking transaction, which may be transmitted or otherwise accessible to the user (e.g., through email, regular mail, access through the application 40 and so on).

While the present invention has been described primarily with respect to automated access to a parking facility, it should be noted that the invention more broadly encompasses a system for communicating via Bluetooth (or Bluetooth low energy) between a mobile device (e.g., a smartphone) and an Internet-connected gateway device (e.g., the gate controller 30 as shown in the example provided by FIG. 1), and thereby gaining full Internet access. Conventionally, Bluetooth low energy (BLE) has been used as a beacon, similar to RFID or NFC, which simply conveys key information between the BLE endpoints. However, the present invention provides full Internet accessibility to a mobile device via BLE communications with an Internet-connected gateway device. As will be readily appreciated by those skilled in the relevant field, this has applications vastly beyond parking. For example, it is contemplated that the system may be used to open and close a) access control devices such as barriers, gates, turnstiles, doors, and locks; b) activate and inactivate access control devices such as visual or aural indicators (i.e. enter or exit lights, signs, or sounds); and c) activate or deactivate utilities (i.e. lights, environmental systems such as heating, air conditioning, refrigeration, ventilation, electrical power, water supply, and air supply, computer equipment, facility equipment, and other equipment), in a building, whether residential (i.e. house or apartment) or commercial (i.e. restaurant or hotel). What is important is that the user's computer device (i.e. smart phone) or identification module (i.e. device connected to vehicle) is configured to communicate with an Internet-connected gateway device via Bluetooth, the Internet-connected gateway device is configured to communicate, via the Internet, with one or more servers (including local servers and remote servers in the Internet “Cloud”), and the one or more servers are configured to signal the Internet-connected gateway device to perform an action. In this context, Bluetooth allows for quick, two-way communication with the user's computing device, enabling the user to interact with the one or more servers in the Internet “Cloud” through prompts and/or push notifications on the user's computing device. In a preferred embodiment, the Internet-connected gateway device establishes a Bluetooth connection with the user's computer device, and enables communication between the user's computer device and the one or more servers, even in areas where neither cellular, nor Wi-Fi connectivity exists.

It should be emphasized that the above-described embodiments of the present disclosure, particularly, any “preferred” embodiments, are merely possible examples of implementations, merely set forth for a clear understanding of the principles of the disclosure. While reference has been made to various preferred embodiments of the invention other variations, implementations, modifications, alterations and embodiments are comprehended by the broad scope of the appended claims. Some of these have been discussed in detail in this specification and others will be apparent to those skilled in the art. For example, while the present disclosure has been described primarily with respect to parking facilities and barrier gates, the features and advantages of the present disclosure can readily be incorporated into other constructs requiring payment or authentication before granting access, such as, for example, toll roads, bridges, ferries, residential and commercial buildings, and so on. Those of ordinary skill in the art having access to the teachings herein will recognize these additional variations, implementations, modifications, alterations and embodiments, all of which are within the scope of the present invention, which invention is limited only by the appended claims.

What is claimed is:

1. An automated facility access and payment processing system, comprising:
an access control device located at a facility, said access control device being configured to grant or deny a user access to or from said facility;
an access control device controller operatively connected to said access control device and configured to cause said access control device to grant or deny said user access to or from said facility;
at least one of: an identification module connected to a vehicle, and a user computer device, each containing user identification information; and
a two-way communication means between said at least one of said identification module and said user computer device, and said access control device controller to allow said at least one of said identification module and said user computer device to transmit said user identification information to said access control device controller in response to receiving a request for said user identification information from said access control device controller;
at least one server operatively connected to said access control device controller, said at least one server being configured to:
a. receive said user identification information from said access control device controller;
b. use said received user identification information to authenticate and process payment for said user; and
c. signal said access control device controller to cause said access control device to grant said user access to or from said facility.

2. The automated facility access and payment processing system as claimed in claim 1, wherein said two-way communication means uses a form of wireless communication.

3. The automated facility access and payment processing system as claimed in claim 2, wherein said form of wireless communication is Bluetooth or Wi-Fi.

4. The automated facility access and payment processing system as claimed in claim 1, wherein said access control device controller is configured to relay messages from said at least one server to said at least one of said identification module and said user computer device.

5. The automated facility access and payment processing system as claimed in claim 1, wherein said user computer device is an Internet appliance, a palm-top computer, a wearable computer, a cellular phone, a mobile phone, a smart phone, a multi-processor system, a processor-based consumer electronic, a programmable consumer electronic, a network computer, a minicomputer, or an onboard vehicle system.

6. The automated facility access and payment processing system as claimed in claim 1, wherein said at least one server includes or is part of a distributed network or cloud computing environment.

7. The automated facility access and payment processing system as claimed in claim 1, wherein said at least one server comprises a facility server in communication with a central authentication and payment processing server, wherein said facility server is configured to provide said steps a., and c., and wherein said central authentication and payment processing server is configured to provide said step b.

8. The automated facility access and payment processing system as claimed in claim 7, wherein said facility server is located proximate to said facility.

9. The automated facility access and payment processing system as claimed in claim 7, wherein said central authentication and payment processing server is located remote from said facility.

10. The automated facility access and payment processing system as claimed in claim 1, wherein said at least one of said identification module and said user computer device comprises an automated facility access and payment processing application facilitating said communication between said at least one of said identification module and said user computer device and said at least one server.

11. The automated facility access and payment processing system as claimed in claim 9, wherein said automated facility access and payment processing application is fully or partially hosted on said at least one server and accessible to said user via said at least one of said identification module and said user computer device.

12. The automated facility access and payment processing system as claimed in claim 1, wherein said access control device controller is further configured activate or deactivate utilities in said facility.

13. The automated facility access and payment processing system as claimed in claim 12, wherein said utilities comprise one or more of: lights, environmental systems, computer equipment, and facility equipment.

14. The automated facility access and payment processing system as claimed in claim 12, wherein said environmental systems comprise one or more of heating, air conditioning, refrigeration, ventilation, electrical power, water supply, and air supply.

15. The automated facility access and payment processing system as claimed in claim 1, wherein said access control device is a barrier, a door, a turnstile, a gate, a lock, a visual indicator, or an aural indicator.

16. The automated facility access and payment processing system as claimed in claim 1, wherein said facility is a parking facility, a toll road, a bridge, a ferry, a residential building, or a commercial building.

17. The automated facility access and payment processing system as claimed in claim 16, wherein said commercial building is a restaurant or a hotel.

18. The automated facility access and payment processing system as claimed in claim 1, further comprising a user detector operatively connected to said access control device controller for detecting entry of said user to, or exit of said user from said facility.

19. The automated facility access and payment processing system as claimed in claim 18, wherein said user detector comprises a radar device, a camera, or an induction loop.

20. The automated facility access and payment processing system as claimed in claim 18, wherein said access control device controller is configured to notify said at least one server upon said user detector detecting said entry of said user to, or exit of said user from said facility.

21. The automated facility access and payment processing system as claimed in claim 18, wherein said user is in a vehicle and said user detector is a vehicle detector for detecting entry of said vehicle to, or exit of said vehicle from said facility.

22. The automated facility access and payment processing system as claimed in claim 1, wherein said two-way communication means operatively connects said at least one of said identification module and said user computer device to the Internet.

23. The automated facility access and payment processing system as claimed in claim 22, wherein said Internet operatively connects said at least one of said identification module and said user computer device to said at least one server.

24. An automated parking facility access and payment processing system, comprising:
a parking facility server located proximate to a parking facility;
a central authentication and payment processing server for authenticating and processing payment for a user of parking facilities;
a gate controller positioned proximate to a barrier gate at the parking facility; and
at least one of: an identification module connected to a vehicle, and a user computer device including or accessing an automated parking and payment processing application;
wherein the gate controller is configured to receive, via Bluetooth communication with the at least one of an identification module and a user computer device, identification information about a user seeking entry into the parking facility, and to relay the identification information to the parking facility server;
wherein the central authentication and payment processing server is configured to receive the identification information from the parking facility server and verify that the user is a valid account holder within the system;
wherein the parking facility server is configured to receive verification from the central authentication and payment processing server and to signal the gate controller to open the barrier gate and allow the user's vehicle to enter the parking facility; and
wherein the gate controller is further configured to detect entry of the vehicle into the parking facility and to provide notification to the central authentication and payment processing server, via the parking facility server, for payment processing.
